(19) United States
(12) Patent Application Publication
(10) Pub. No.: US 2026/0244984 A1
(43) Pub. Date: Aug. 20, 2026

(54) Mechanism for Neural Network Processing Unit Skipping

(71) Applicant: Arm Limited, Cambridge (GB)

(72) Inventors: Neil Burgess, Cardiff (GB); Sangwon Ha, Cambridge (GB); Partha Prasun Maji, Cambridge (GB)

(73) Assignee: Arm Limited, Cambridge (GB)

(21) Appl. No.: 19/102,492

(22) PCT Filed: Aug. 9, 2023
(86) PCT No.: PCT/GB2023/052107

§ 371 Date: Feb. 10, 2025

(30) Foreign Application Priority Data
Aug. 11, 2022 (GB) 2211748.5

(51) Int. Cl. G06N 20/00

(52) U.S. Cl. CPC G06N 20/00

(57) ABSTRACT

A system and computer-implemented method to train and use a neural network is disclosed. For each group of elements of a feature map in a layer in the neural network, a record is accessed to determine if at least one element of the group is active. When at least one element of the group is active, a gradient is determined for each active element of the group, copied to a 5 group element position indicated by the entry for the group in record, and the group is sent to a dot product unit to update weights in the layer based on the group. When no element of the group is active, the dot product unit is signaled to prevent update of weights based on the group. The record is set during the forward path of the feature map through the network.

### BACKGROUND

A neural network may include multiple processing layers. In a layer, input data are weighted and combined using a set of weights to produce a pre-activation feature map. The pre-activation features are then passed through an activation function unit and, optionally, other units such as a dropout unit or a pooling unit. The weight values are adjusted during a training phase using a backpropagation technique, in which gradient estimates are passed back through the layers.

A commonly used activation function unit is a rectified linear unit (ReLU) that sets negative pre-activation features to zero. A dropout unit may also randomly set activations to zero and a pooling unit discards activations other than the activation having the largest value. During training, computations are used to determine which gradients are associated with non-zero activations and are to be backpropagated. In prior approaches, the pooling references its input feature map, created during the forward path, and copies the gradient to the appropriate element in the feature map. All other elements within the pooling window are set to zero. The dropout unit and activation function unit, in turn, reference the feature map again to determine whether to backpropagate the gradients by checking if the element value is a non-zero number or a positive number, respectively. This approach is inefficient since these checks were previously made during the forward path through the layer.

### BRIEF DESCRIPTION OF THE DRAWINGS

The accompanying drawings provide visual representations which will be used to describe various representative embodiments more fully and can be used by those skilled in the art to better understand the representative embodiments disclosed and their inherent advantages. In these drawings, like reference numerals identify corresponding or analogous elements.

FIG. 1A is a simplified block diagram of a data processor for training a neural network, in accordance with an embodiment of the disclosure.

FIG. 1B is a simplified block diagram of a data processing system for implementing a neural network, in accordance with an embodiment of the disclosure.

FIG. 2 is a block diagram of a neural network, in accordance with various representative embodiments of the disclosure.

FIG. 3 is a block diagram of a feature detector, in accordance with various representative embodiments of the disclosure.

FIG. 4 is a block diagram showing the use of a record during weight training of a neural network, in accordance with various representative embodiments of the disclosure.

FIG. 5 is a flow chart of a method for generating a record, in accordance with various representative embodiments of the disclosure.

FIG. 6 is a flow chart of a method for training a neural network, in accordance with various representative embodiments of the disclosure.

FIG. 7 is a diagram illustrating forward processing of an example group of elements, in accordance with various representative embodiments of the disclosure.

FIG. 8 is a diagram illustrating forward processing of a further example group of elements, in accordance with various representative embodiments of the disclosure.

FIG. 9 is a block diagram showing an example of backpropagation in a layer of a neural network, in accordance with various representative embodiments of the disclosure.

FIG. 10 is a block diagram showing a further example of backpropagation in a layer of a neural network, in accordance with various representative embodiments of the disclosure.

FIG. 11 shows an example of element scaling in the forward path of a neural network, in accordance with various representative embodiments of the disclosure.

FIG. 12 shows an example of gradient scaling in the backward path of a neural network, in accordance with various representative embodiments of the disclosure.

### DETAILED DESCRIPTION

The various apparatus and devices described herein provide mechanisms for improving the efficiency of neural network training.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

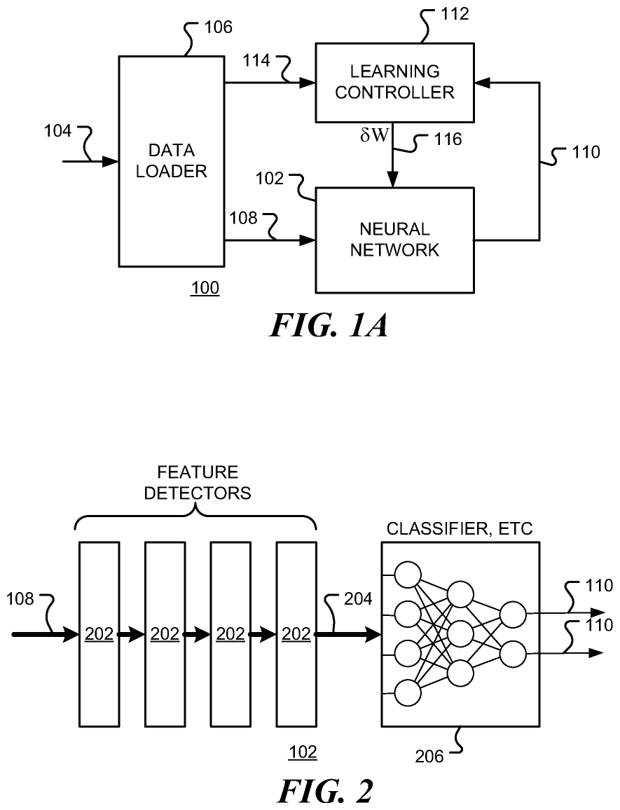

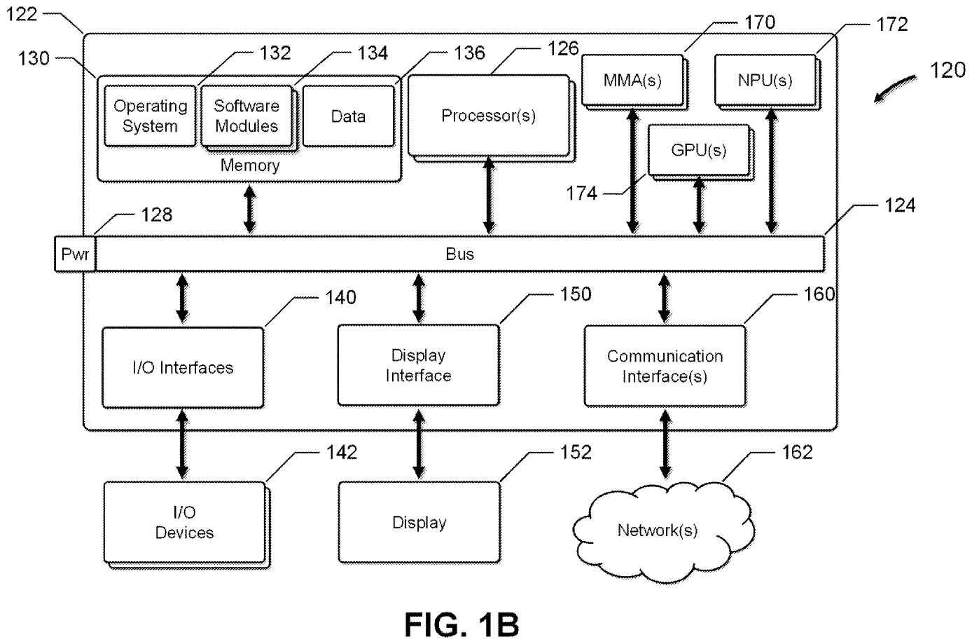

FIG. 1A is a simplified block diagram of a data processor 100 for training a neural network 102, in accordance with an embodiment of the disclosure. Data processor 100 may be implemented, for example, on custom hardware, such as a hardware accelerator, a general-purpose processor, a graphics processing unit, a vector processor, an array processor or any combination thereof. Training data 104 is provided to train the neural network for a chosen task. The training data includes a set of training inputs and corresponding target training outputs. During training, a data loader 106 is configured to supply inputs 108 to neural network 102 to produce outputs 110. For example, outputs 110 may be labels classifying information in inputs 108. Outputs 110 are passed to learning controller 112, where output 110 is compared to a corresponding desired training output 114. Network weights, W, of neural network 102 are adjusted by an amount δW (116), to reduce a cost function based on a difference between desired training output 114 and output 110. Other types of learning may be used to determine the weights, W.

FIG. 1B depicts a block diagram of system 120, in accordance with an embodiment of the present disclosure. System 120 executes, inter alia, the trained neural network during inference. In some embodiments, system 120 may also train the neural network; in other embodiments, one or more higher-performance computers train the neural network, such as a computer with multiple, multi-core CPUs, one or more NPUs and/or GPUs, etc.

Computer 122 includes bus 124 coupled to one or more processors 120, memory 130, I/O interfaces 140, display interface 150, and one or more communication interfaces 160. In many embodiments, computer 122 also includes one or more special processors, such as, for example, MMAs 170, NPUs 172, GPUs 174, etc. Generally, I/O interfaces 140 are coupled to I/O devices 142 using a wired or wireless connection, display interface 150 is coupled to display 152, and communication interface 160 is connected to network 162 using a wired or wireless connection.

Bus 124 is a communication system that transfers data between processor 126, memory 130, I/O interfaces 140, display interface 150, communication interface 160, MMA 170, NPU 172 and GPU 174, as well as other components not depicted in FIG. 1B. Power connector 128 is coupled to bus 124 and a power supply (not shown).

Processor 126 includes one or more general-purpose or application-specific microprocessors that executes instructions to perform control, computation, input/output, etc, functions for computer 122. Processor 126 may include a single integrated circuit, such as a micro-processing device, or multiple integrated circuit devices and/or circuit boards working in cooperation to accomplish the functions of processor 126. In addition, processor 126 may execute computer programs or modules, such as operating system 132, software modules 134, etc., stored within memory 130. For example, software modules 134 may include an machine learning application, an ANN application, a CNN application, etc.

Generally, storage element or memory 130 stores instructions for execution by processor 126 and data. Memory 130 may include a variety of non-transitory computer-readable medium that may be accessed by processor 126. In various embodiments, memory 130 may include volatile and nonvolatile medium, non-removable medium and/or removable medium. For example, memory 130 may include any combination of random access memory (RAM), dynamic RAM (DRAM), static RAM (SRAM), read only memory (ROM), flash memory, cache memory, and/or any other type of non-transitory computer-readable medium.

Memory 130 contains various components for retrieving, presenting, modifying, and storing data. For example, memory 130 stores software modules that provide functionality when executed by processor 126. The software modules include operating system 132 that provides operating system functionality for computer 122. Software modules 134 provide various functionality, such as image classification using convolutional neural networks, etc. Data 136 may include data associated with operating system 132, software modules 134, etc.

I/O interfaces 140 are configured to transmit and/or receive data from I/O devices 142. I/O interfaces 140 enable connectivity between processor 126 and I/O devices 142 by encoding data to be sent from processor 126 to I/O devices 142, and decoding data received from I/O devices 142 for processor 126. Generally, data may be sent over wired and/or wireless connections. For example, I/O interfaces 140 may include one or more wired communications interfaces, such as USB, Ethernet, etc., and/or one or more wireless communications interfaces, coupled to one or more antennas, such as WiFi, Bluetooth, cellular, etc.

Generally, I/O devices 142 provide input to computer 122 and/or output from computer 122. As discussed above, I/O devices 142 are operably connected to computer 122 using a wired and/or wireless connection. I/O devices 142 may include a local processor coupled to a communication interface that is configured to communicate with computer 122 using the wired and/or wireless connection. For example, I/O devices 142 may include a keyboard, mouse, touch pad, joystick, etc.

Display interface 150 is configured to transmit image data from computer 122 to monitor or display 152.

Communication interface 160 is configured to transmit data to and from network 162 using one or more wired and/or wireless connections. Network 162 may include one or more local area networks, wide area networks, the Internet, etc., which may execute various network protocols, such as, for example, wired and/or wireless Ethernet, Bluetooth, etc. Network 162 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

MMA 170 is configured to multiply matrices and generate output matrices to support various applications implemented by software modules 134, such as, for example, machine learning applications, artificial neural network applications, etc. Similarly, NPU 172 and GPU 174 are generally configured, inter alia, to execute at least a portion of an artificial neural network to support various applications implemented by software modules 134.

FIG. 2 is a block diagram of a neural network 102, in accordance with embodiments of the disclosure. Neural network 102 includes an input layer 201 that receives inputs 108, such as, for example, image data, etc., and a number of feature detectors 202, the last of which generates final feature map 204. Feature detectors 202 include and one or more hidden layers such as convolution networks, for example. In the example shown, final feature map 204 is passed to classifier 206 that, in turn, produces outputs 110. However, in general, the neural network may be used for applications other than classification. Neural network 102 may be implemented, for example, using custom hardware, such as a neural processor, or in software executed on a programmable processor, or a combination thereof. Once trained, neural network 102 may be used for inference.

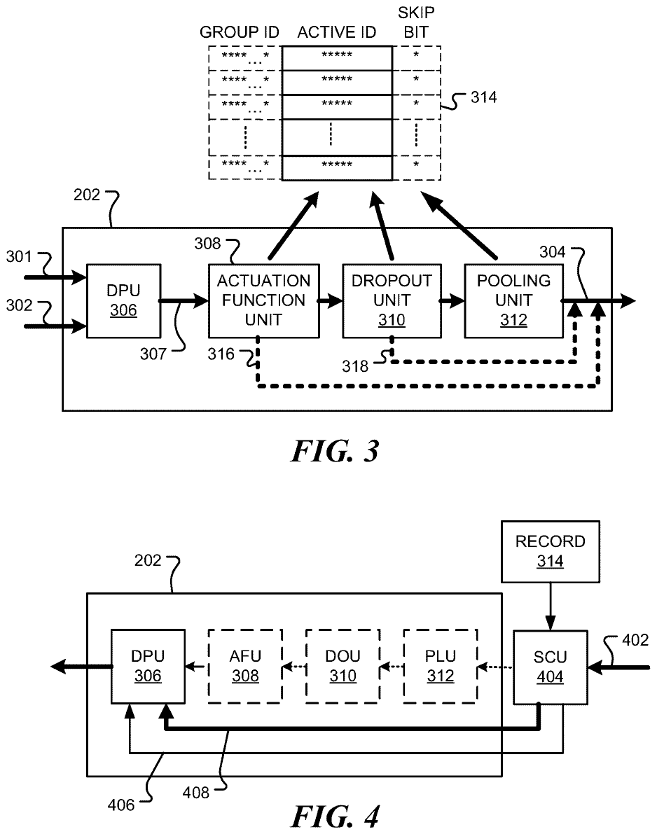

FIG. 3 is a block diagram of at least one feature detector 202, in accordance with various embodiments of the disclosure. Generally, feature detector 202 receives weights 301 and input feature map 302, and generates output feature map 304. Feature detector 202 includes a dot product unit (DPU) 306 that computes weighted combinations of weights 301 and elements of input feature map 302 to produce pre-activation feature map 307 that is passed to activation function unit (AFU) 308. In the example shown, AFU 308 is a rectifying linear unit (ReLU) that scans pre-activation feature map 307, sets to zero any element having a negative value, and generates post-activation feature map 309. Herein, an “element” refers to a location in a feature map-either pre-activation or post-activation. For example, in a feature map of an image, an element may correspond to a “pixel.” However, it is to be understood that the present disclosure is not limited to training neural networks for analyzing visual images or pictures. The disclosed training mechanisms may be used to train a neural network to analyze other types of data. For example, neural networks may be used for analyzing sensor data for controlling driverless cars and robots, for analyzing documents, for analyzing medical information, etc.

Optionally, the feature detector may include dropout unit (DOU) 310 which is configured to set random elements in post-activation feature map 309 to zero for a dropout effect.

Finally, a pooling unit (PLU) 312 takes each non-overlapping pooling window in post-activation feature map 309, received from either AFU 308 or optional DOU 310, reduces it down to a single element, and generates output feature map 304. For example, the single element may be the maximum value within a pooling window. Post-activation feature map 309 may be divided up into non-overlapping windows.

Generally, DPU 306, AFU 308, DOU 310 and PLU 312 are known as processing units (PUs), as each one applies a particular processing function to the data flowing through feature detector 202.

In accordance with various embodiments of the present disclosure, record 314 is stored in a storage device of the data processor. Record 314 may be a mask table, for example. The storage device may be a cache or other memory, for example. Record 314 may be associated with a single layer or feature detector, but each record is shared between an AFU and one or more subsequent DOU(s) 310 and/or PLU(s) 312. Pre-activation feature map 307 for the layer is divided into a number of non-overlapping groups of elements. Each entry in the record corresponds to a group in post-activation feature map 309 and includes a field (ACTIVE ID) that indicates which element(s) in the group are active. Optionally, an entry may include a group identifier (GROUP ID) to specify which group is associated with the entry. However, the group identifier may be inferred from the location of an entry in the record. When AFU 308 receives a group of pre-activations, it stores an entry into the ACTIVE ID field of the layer's dedicated record. The ACTIVE ID indicates which elements, if any, of this group have a positive value. The entry may include one bit per element of the group; when a bit is set to logic value one (1), the corresponding element is enabled or activated. If no element has a positive value, the ACTIVE ID field is set to zero and the DOU 310 and PLU 312 may be by-passed, as indicated by broken line 316, and the output 304 is set to zero. Similarly, if all positive element values are dropped by DOU 310, the ACTIVE ID field is set to zero and the PLU 312 may be by-passed, as indicated by broken line 318. Otherwise, DOU 310 and PLU 312 receive the output of AFU 308. DOU 310 updates the ACTIVE ID field according to which elements, if any, are dropped out. PLU 312 updates the ACTIVE ID field according to which element contains the maximum value for that window. In certain embodiments, DOU 310 is not present, and PLU 312 receives the output of AFU 308.

Optionally, the record may contain a skip-bit entry for each group. The entry is a single bit that is asserted (e.g., set to one) when no element in the group is active, and de-asserted (e.g., set to zero) when at least one group is active. Equivalently, the logic could be reversed, and a do-not-skip bit used. Equivalent information is contained in the ACTIVE ID field, but a single bit is simpler to check.

If an entry in the ACTIVE ID field of the record has been set to indicate that a element of a feature map was not active during forward propagation, gradient propagation for that element is not required.

During backpropagation, PLU 312's reduction in the forward path is reversed by propagating the gradient to the element which had the maximum value while setting all others to zero. Next, DOU 310 and AFU 308 will propagate the gradient to those elements which had a non-zero and a positive activation value, respectively. Finally, the gradient will find its way to DPU 306 for computing weight and input gradients. In prior approaches, PLU 312 references its input feature map, created during the forward path, and copies the gradient to the appropriate element. All other elements within the pooling window are set to zero. DOU 310 and AFU 308, in turn, reference the feature map again to determine whether to backpropagate the gradients by checking if the element value is a non-zero number or a positive number, respectively. This approach is inefficient since these checks were previously made during the forward path through the layer.

FIG. 4 is a block diagram showing the use of record 314 during weight training, in accordance with various embodiments of the disclosure. FIG. 4 illustrates the backpropagation of gradients 402 to DPU 306, which is used to compute updates to the weights of the layer based on backpropagated gradients. During backpropagation of gradients for a group, skip control unit (SCU) 404 reads an entry from record 314 for the group. If the skip bit is asserted, SCU 404 sends a signal 406 directly to DPU 306 to notify it that the product term for this group will be zero and does not require further computation. Otherwise, when the skip bit is not-asserted, gradient 408 is propagated to the element position in the feature map. Thus, PLU 312, DOU 310 and AFU 308 are by-passed during backpropagation.

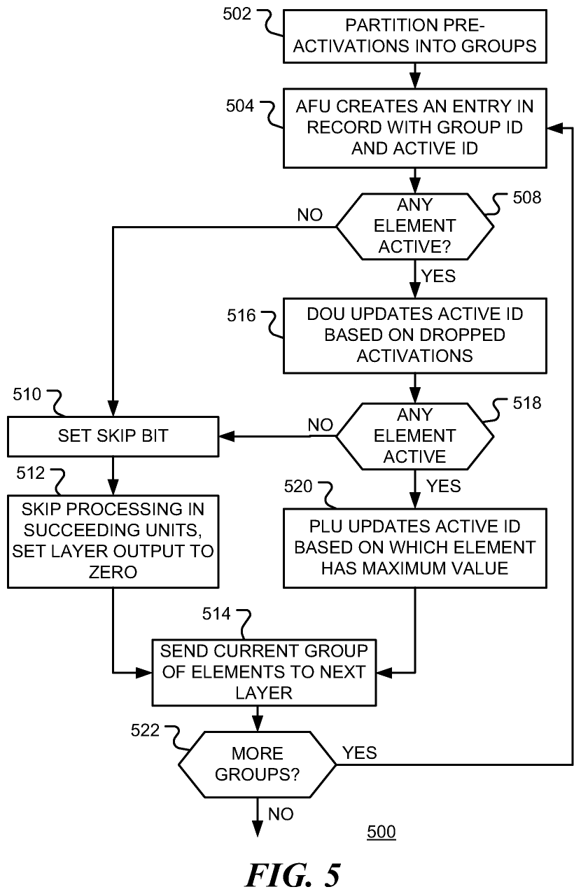

FIG. 5 is a flow chart 500 of a method for generating a record, in accordance with various embodiments of the disclosure. At block 502, pre-activations of a feature map are partitioned into groups of a designated size. At block 504, AFU 308 creates an entry, associated with the group, in the record. The entry includes an indicator in an ACTIVE ID field of which elements in the group are active. A group identifier may also be added to the entry, or the group identifier may be inferred from the location (relative or absolute) of the entry in the record. If no element in the group is active, as depicted by the negative branch from decision block 508, a skip bit may be set at 510. At block 512, processing by DOU 310 and PLU 312 is bypassed and the output from the current group is set to zero. The output is sent to the next layer at block 514; alternatively, the group outputs are formed into an output feature map that is sent to the next layer after decision block 522. If at least one element in the group is active, as depicted by the positive branch from decision block 508, DOU 310 selects activations to be dropped, sets the corresponding elements to zero and updates the entry in the ACTIVE ID field based on which elements have been dropped. If the updated ACTIVE ID entry indicates that no element in the group is active, as depicted by the negative branch from decision block 518, the skip bit may be set at 510. If the updated ACTIVE ID entry indicates that at least one element in the group is active, as depicted by the positive branch from decision block 518, PLU 312 updates the entry in the ACTIVE ID field to indicate which element in the current group has the largest value. The output is sent to the next layer at block 514; alternatively, the group outputs are formed into an output feature map that is sent to the next layer after decision block 522. The process is repeated for remaining groups in the feature map, as indicated by the positive branch from decision block 522. If there are no more groups to be processed, as depicted by the negative branch from decision block 522, forward processing the current feature map in this layer is complete.

In a further embodiment, processing in the layer may include determining a element of a group to be active if it is activated by AFU 308 of the layer and retained by a DOU 310 of the layer. When at least one element of a group of the feature map is active, a PLU 312 of the layer selects the element having a maximum value in the group as output and sends a signal (e.g., an instruction) to write an entry in record 314. The entry is associated with the group and indicating the element selected by the PLU 312. When no element of the group is active, processing of the group by PLU 312 is skipped. Optionally, a skip bit in the entry associated with the group is set when no element of the group is active and cleared otherwise.

In one embodiment, DOU 310 and PLU 312 may determine whether to process the group. DOU 310 may read the entry associated with the group in record 314 to determine whether at least one element in the group is active. In this embodiment, AFU 308 created or updated the entry in record 314 based on its processing. If at least one element of the group is active, DOU 310 processes the group, and if none of the elements of the group is active, DOU 310 skips processing the group. DOU 310 then updates the entry in record 314 based on its determination. Similarly, PLU 312 may read the entry associated with the group in record 314 to determine whether at least one element in the group is active. If at least one element is active, PLU 312 processes the group, and if none of the elements of the group is active, PLU 312 skips processing the group. PLU 312 then updates the entry in record 314 based on its determination.

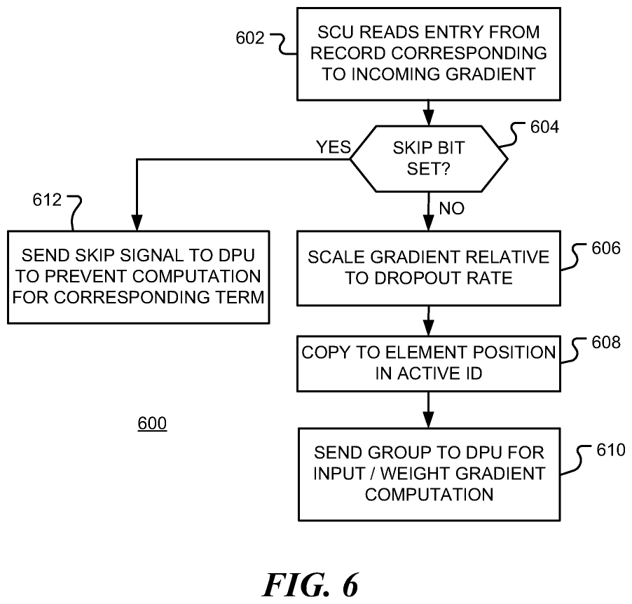

FIG. 6 is a flow chart 600 of a method for training a neural network, in accordance with various embodiments of the disclosure. The flow chart depicts operations for updating weights in a layer of the neural network using backpropagation. For each group of a feature map in the layer, at block 602, SCU 404 determines, from an entry in record 314 associated with the layer, if at least one element of the group associated with incoming backpropagation data is active. This may be done, for example, by reading a skip bit in the entry or by checking bits in an ACTIVE ID field of the entry. In the example shown, a skip bit is tested. When at least one element of the group is active, as depicted by the negative branch from decision block 604, a gradient is determined for each active element of the group at block 606. This may be done, for example, by scaling an incoming gradient in accordance with a dropout rate for the DOU 310 in the layer. At block 608, the gradient is copied to a group element position indicated by the entry in the ACTIVE ID for the group in record 314 and, at block 610, the group is sent to a DPU 306 to update weights in the layer based on the group. When no element of the group is active, as depicted by the positive branch from decision block 604, the DPU 306 is signaled at block 612 to prevent update of weights based on the group.

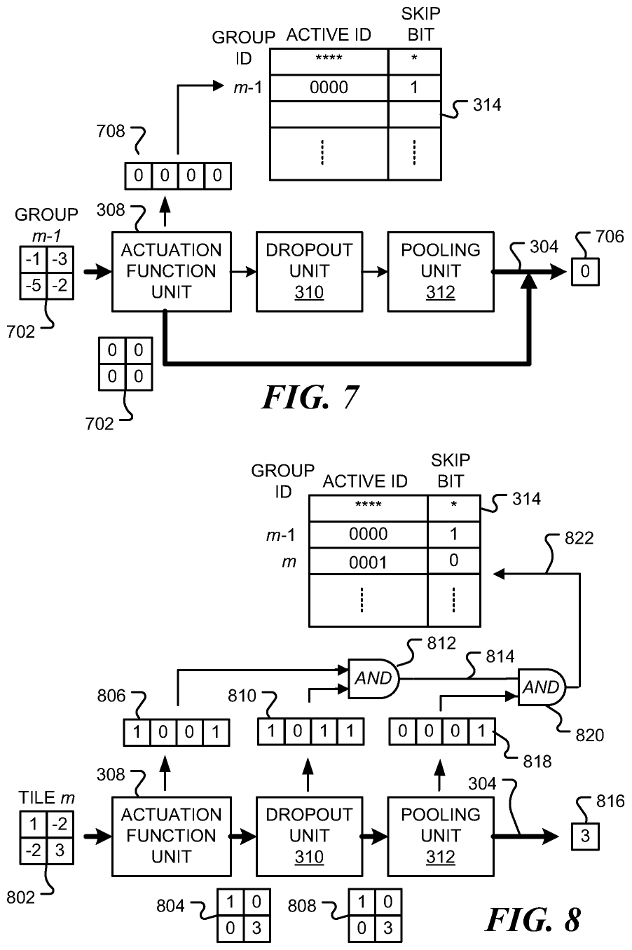

FIG. 7 is a diagram illustrating forward processing of an example group, in accordance with various embodiments of the disclosure. Group 702, with index m−1 in the feature map, is input to AFU 308. In this example, all of the four elements in the group have negative values. These values are set to zero by AFU 308 resulting in group 704. No further processing is required, so output 304 is a single zero element 706. The bit mask {0000} (708) is stored in the ACTIVE ID entry for group m−1 in record 314.

FIG. 8 is a diagram illustrating forward processing of a further example group, in accordance with various embodiments of the disclosure. Group 802, with index m in the feature map, is input to AFU 308. In this example, two of the four elements in the group have positive values and are unchanged by AFU 308. The other two values are negative and are set to zero by AFU 308. Resulting group 804 is passed from AFU 308 to DOU 310. The AFU bit mask is set to {1001} (806). In the example shown, DOU 310 drops the second element but retains the other three. Group 808 is passed from DOU 310 to PLU 312. The DOU bit mask is set to {1011} (810). The AFU and DOU bit masks are combined in logical AND unit 812 to produce combined bit mask 814. PLU 312 selects the largest element and provides the value 816 at output 304. The PLU bit mask is set to {0001} (818). Combined bit mask 814 and PLU bit mask 818 are combined in logical AND unit 820 to produce final bit mask 822. The final bit mask is stored in the ACTIVE ID field of record 314 at the location associated with group m.

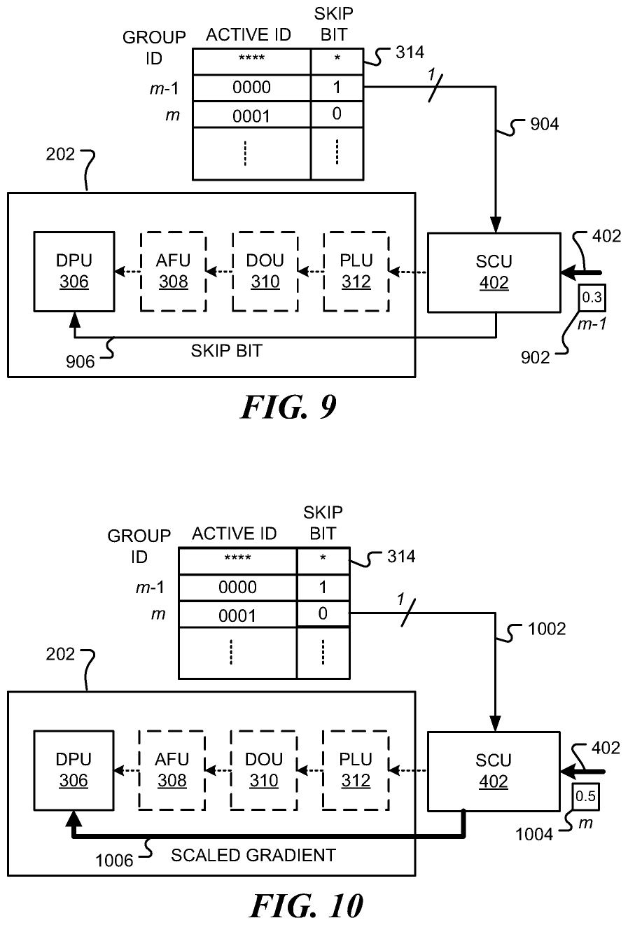

FIG. 9 is a block diagram showing an example of backpropagation in a layer of a neural network, in accordance with various embodiments of the disclosure. Gradient 902 for group m−1 is received from the adjacent layer by SCU 404. SCU 404 accesses the skip bit from the entry associated with group m−1 in record 314, as indicated by arrow 904. In the example, shown, the skip bit for group m−1 is set to one, so the skip controller signals DPU 306, as indicated by arrow 906, to indicate that the no update is needed for group m−1. In contrast, in prior approaches the gradient 902 is passed to DPU 306 via PLU 312, DOU 310 and AFU 308. In the disclosed approach, PLU 312, DOU 310 and AFU 308 are bypassed, reducing the number of operations needed.

FIG. 10 is a block diagram showing a further example of backpropagation in a layer of a neural network, in accordance with various embodiments of the disclosure. Gradient value 1002 for group m is received from the adjacent layer by SCU 404. SCU 404 accesses the skip bit from the entry associated with group m in record 314, as indicated by arrow 1004. In the example, shown, the skip bit for group m is not set, so at least one element in the group was active in the forward path. SCU 404 copies the scaled gradient to elements indicated by the ACTIVE ID field in record 314. The scaled gradients are sent to DPU 306, as indicated by arrow 1006, to be used to update weights associated with the active elements in group m. As in the previous examples, PLU 312, DOU 310 and AFU 308 are bypassed. The scaling factor used to scale the gradients may be based on the dropout rate of DOU 310 in addition to a learning factor.

In an example embodiment, the group size is 2×4×4 (CxHxW), so an ACTIVE ID entry uses 2⁵ bits per group. Other group sizes may be used without departing from the present disclosure. A skip bit is used, requiring 1 bit per group. The pre-activation feature map has 64×128×128=2²⁰ elements, which is divided into 32×32×32=2¹⁵ groups. Thus, there are 2¹⁵ entries in the record. The total memory used to store the record is 2¹⁵ groups×2⁵ bits/group=2²⁰ bits=2¹⁷ Bytes. This corresponds to a memory overhead of about 3%. When a max pooling unit is used and pooling window is one group, only one element is active per group. In an alternative embodiment, a 5-bit element index could be used, together with a skip bit, in place of a 32-bit bit mask.

TABLE 1 shows the computational reductions obtained by use of a record for the example described above. Assuming at least one element is active, the forward path uses the same number of computations as previous approaches but uses additional ‘write’ operations to create the record. However, the backward path requires far fewer computations, since the AFU 308, DOU 310 and PLU 312 are by-passed. The net saving is about 61×2¹⁵ operations, or about 32%. In the table, “comp” indicates a computation or operation, and “write” indicates a write operation to the record.

TABLE 1

| | | AFU | DOU | PLU | SU | SUBTOTAL |
|---|---|---|---|---|---|---|
| Forward | Prior art | 2²⁰ comp | 2²⁰ comp | 2²⁰ comp | 0 | 3 × 2²⁰ |
| | Proposed | +2¹⁵ write | +2¹⁵ write | +2¹⁵ write | 0 | +3 × 2¹⁵ |
| Backward | Prior art | 2²⁰ comp | 2²⁰ comp | 2²⁰ comp | 0 | 3 × 2²⁰ |
| | Proposed | −2²⁰ comp | −2²⁰ comp | −2²⁰ comp | +2²⁰ comp | −2²¹ |

| | |
|---|---|
| Total Difference | −61 × 2¹⁵ |

When a dropout unit is used, features and gradients may be scaled to compensate for dropped elements.

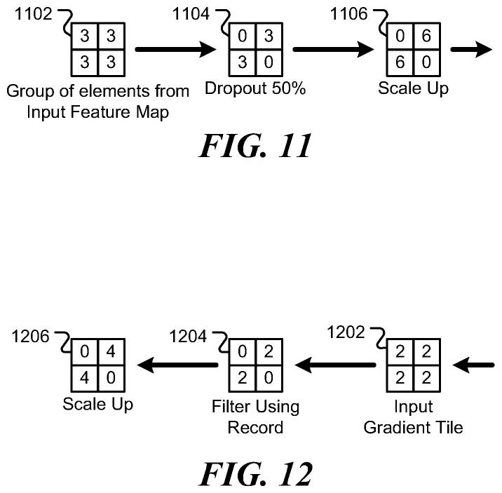

FIG. 11 shows an example of element scaling in the forward path. Input group 1102 of a feature map is passed through a dropout unit with a 50% dropout rate to produce group 1104. Group 1104 is then scaled up by a factor of two to produce scaled group 1106. The scaling compensates for the 50% of elements that were discarded by the dropout unit. Scaled group 1106 may be passed to a pooling unit or to a next layer in the neural network.

FIG. 12 shows an example of gradient scaling in the backward path. Gradient group 1202 is filtered in accordance with the corresponding ACTIVE ID entry in a record to produce filtered gradient group 1204, which is then scaled up by a factor of two to produce scaled gradient group 1206. The scaling compensates for the 50% of elements that were discarded by the dropout unit as the group propagated the forward path.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to”, when applied to an element, means that the element may be designed or constructed to perform a designated or fixed function, or that is has the required structure to enable it to be reconfigured or adapted to perform that function, as in fixed function hardware.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure. For example, the processing units (PU) may be each configured as fixed function hardware to process data associated with an input feature map. Certain units of the PU, such as DPUs, AFUs, PLUs and DOUs may likewise be fixed function hardware as described above.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted without departing from the present disclosure. Such variations are contemplated and considered equivalent.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. A processor for performing machine learning training, comprising:
a plurality of processing units (PUs), each PU configured to process data associated with an input feature map,
where at least one PU is configured to:
send a signal to a memory indicating whether elements in a group of elements of a post-activation feature map are active or inactive, and
bypass processing the group of elements of the post-activation feature map by subsequent PUs when none of the elements of the group of elements of the post-activation feature map is active.

2. The processor according to claim 1, where:
the signal includes an instruction to write an entry associated with the group in a record in the memory; and
the entry includes:
a bit for each element of the group indicating whether the element is active or not active, or
a bit indicating whether at least one element of the group is active.

3. The processor according to claim 1, where the PUs include:
a dot product unit (DPU) configured to:
generate a pre-activation feature map based on weights and the input feature map, the pre-activation feature map including a plurality of groups, each group including a plurality of elements; and
an activation function unit (AFU) configured to:
apply an activation function to a group of elements of the pre-activation feature map to generate a group of elements of the post-activation feature map,
send the signal to the memory indicating whether elements in the group of elements of the post-activation feature map are active or inactive, and
bypass processing the group of elements of the post-activation feature map by subsequent PUs when none of the elements of the group of elements of the post-activation feature map is active.

4. The processor according to claim 3, where the PUs include:
a pooling unit (PLU) configured to:
apply a pooling function to the group of elements of the post-activation feature map to generate a group of elements of an output feature map; and
a dropout unit (DOU), disposed between the AFU and the PLU, configured to:
apply a dropout function to the group of elements of the post-activation feature map;
send the signal to the memory indicating whether elements in the group of elements of the post-activation feature map are active or inactive; and
bypass processing the group of elements of the post-activation feature map by the pooling unit when none of the elements of the group of elements of the post-activation feature map is active.

5. (canceled)

6. The processor according to claim 1, where each subsequent PU is configured to:
access the memory; and
process the group of elements of the post-activation feature map when at least one of the elements of the group of elements of the post activation feature map is active.

7. The processor according to claim 6, where:
said access the memory includes read an entry associated with the group in a record in the memory; and
the entry includes:
a bit for each element of the group indicating whether the element is active or not active, or
a bit indicating whether at least one element of the group is active.

8. A processor-based method for performing machine learning training, comprising:
processing, by a plurality of processing units (PUs), data associated with an input feature map;
during the processing:
sending, by at least one PU of one or more processing units (PUs), a signal to a memory configured to receive signals from the one or more PUs indicating whether elements in a group of elements of a post-activation feature map are active or inactive; and
bypassing, by the one PU, processing the group of elements of the post-activation feature map by subsequent PUs when none of the elements of the group of elements of the post-activation feature map is active.

9. The processor-based method according to claim 8, where:
the signal includes an instruction to write an entry associated with the group in a record in the memory; and
the entry includes:
a bit for each element of the group indicating whether the element is active or not active, or
a bit indicating whether at least one element of the group is active.

10. The processor-based method according to claim 8, where said processing includes:
at a dot product unit (DPU):
generating a pre-activation feature map based on weights and the input feature map, the pre-activation feature map including a plurality of groups, each group including a plurality of elements;
at an activation function unit (AFU):
applying an activation function to the elements of a group of elements of the pre-activation feature map to generate a group of elements of the post-activation feature map;
at a dropout unit (DOU):
applying a dropout function to the group of elements of the post-activation feature map; and
at a pooling unit (PLU):
applying a pooling function to the group of elements of the post-activation feature map to generate a group of elements of an output feature map.

11. the processor of claim 1, further comprising:
the memory configured to receive signals from one or more of the PUs indicating whether elements in a group of elements of a post-activation feature map are active or inactive; and
a skip control unit (SCU) configured to:
access the memory, and
bypass back-propagating gradient data to the PUs when none of the elements of the group of elements of the post-activation feature map is active.

12. The processor according to claim 11, where:
said access the memory includes read an entry associated with the group in a record in the memory; and
the entry includes:
a bit for each element of the group indicating whether the element is active or not active, or
a bit indicating whether at least one element of the group is active.

13. The processor according to claim 11, where the PUs include:
a dot product unit (DPU) configured to generate a pre-activation feature map based on weights and the input feature map, the pre-activation feature map including a plurality of groups, each group including a plurality of elements; and
an activation function unit (AFU) configured to apply an activation function to the elements of a group of elements of the pre-activation feature map to generate a group of elements of the post-activation feature map.

14. The processor according to claim 13, where the PUs include:
a dropout unit (DOU) configured to apply a dropout function to the group of elements of the post-activation feature map; and
a pooling unit (PLU) configured to apply a pooling function to the group of elements of the post-activation feature map to generate a group of elements of an output feature map.

15. The processor according to claim 13, where, when at least one of the elements of the group of elements of the post-activation feature map is active:
the SCU is configured to:
back-propagate the gradient data to the PUs; and
update the weights based on the back-propagated gradient data.

16. The processor according to claim 15, where said back-propagate the gradient data includes scale the gradient data to a dropout rate.

17. the method of claim 8, further comprising:
accessing, by at a skip control unit (SCU), the memory configured to receive signals from one or more of processing units (PUs) of the plurality of PUs indicating whether elements in a group of elements of a post-activation feature map are active or inactive; and
bypassing, by the SCU, back-propagating a gradient to the PUs when none of the elements of the group of elements of the post-activation feature map is active,
where each PU is configured to process data associated with an input feature map.

18. The processor-based method according to claim 17, where:
said accessing the memory includes reading an entry associated with the group in a record in the memory; and
the entry includes:
a bit for each element of the group indicating whether the element is active or not active, or
a bit indicating whether at least one element of the group is active.

19. The processor-based method according to claim 17, where the PUs include:
a dot product unit (DPU) configured to generate a pre-activation feature map based on weights and the input feature map, the pre-activation feature map including a plurality of groups, each group including a plurality of elements;
an activation function unit (AFU) configured to apply an activation function to the elements of a group of elements of the pre-activation feature map to generate a group of elements of the post-activation feature map;
a dropout unit (DOU) configured to apply a dropout function to the group of elements of the post-activation feature map; and
a pooling unit (PLU) configured to apply a pooling function to the group of elements of the post-activation feature map to generate a group of elements of an output feature map.

20. The processor-based method according to claim 19, where, when at least one of the elements of the group of elements of the post-activation feature map is active, the method further comprises:
at the SCU:
back-propagating the gradient to the PUs including scaling the gradient data to a dropout rate; and
updating the weights based on the back-propagated gradient.

21. The processor of claim 1 for performing machine learning inference,
where at least one PU is configured to:
determine whether elements in a group of elements of a post-activation feature map are active or inactive, and
bypass processing the group of elements of the post-activation feature map by subsequent PUs.

22. (canceled)

23. (canceled)

24. (canceled)

25. The for performing machine learning inference, further comprising:
during the processing:
determining, by at least one PU, whether elements in the group of elements of the post-activation feature map are active or inactive; and
bypassing, by the at least one PU, processing the group of elements of the post-activation feature map by subsequent PUs.

26. (canceled)

27. (canceled)
